(19) United States
(12) Patent Application Publication
(10) Pub. No.: US 2014/0232044 A1
(43) Pub. Date: Aug. 21, 2014

(54) DISTRIBUTION SYSTEM FOR INJECTION MOULDING

(71) Applicant: BOREALIS AG, Vienna (AT)

(72) Inventor: Harald Herbst, Linz (AT)

(21) Appl. No.: 14/350,242

(22) PCT Filed: Oct. 8, 2012
(86) PCT No.: PCT/EP2012/069840

§ 371 Date: Apr. 7, 2014

(30) Foreign Application Priority Data
Oct. 11, 2011 (EP) 11184705.9

(51) Int. Cl. B29C 45/00

(52) U.S. Cl. CPC B29C 45/0046; B29C 2045/0051
USPC 264/328.8; 425/560

(57) ABSTRACT

A distribution system 18 of an injection moulding system 10 comprises an inlet 19 for receiving pressurized liquid plastic material, at least a first nozzle 24a and a second nozzle 24b for injecting liquid plastic material into a mould cavity 34, a distributor 20 for distributing the liquid plastic material from the inlet 19 over a first flow path 40a to the first nozzle 24a and over a second flow path 40b to the second nozzle 24b. The distribution system 18 is adapted for sequentially injecting liquid plastic material into the mould cavity 34 via the first flow path 40a and the second flow path 40b. The distribution system 18 is adapted for reducing pressure energy of liquid plastic material in the distributor 20, when liquid plastic material is injected into the mould cavity 34 via the first flow path 40a.

### FIELD OF THE INVENTION

The invention relates to the field of injection moulding. In particular, the invention relates to a distribution system for an injection moulding system, an injection moulding system and a method for injection moulding.

### BACKGROUND OF THE INVENTION

Injection moulding is a method in which heated and liquefied thermoplastic material may be pressed into a mould cavity where it cools and cures. Injection moulding is the mostly used conversion technology for thermoplastic polymer materials, by which final parts of any dimensions may be produced. The range of dimensions of the parts covers the microscale from small parts (small gears, medicine technique) to mid size parts of typical part dimensions of some dm (packaging, carrier, automotive parts, . . . ) to big scale parts (dimension 1 to 2 m) like bumpers, dashboards, rocker panels or body panels for the automotive industry. Depending on the dimensions of the parts being produced specific injection moulding technologies may be applied.

One of those methods is sequential filling. In particular for big scale parts, for examples bumpers, the flow ability of most of the thermoplastic parts may hinder the filling of the part by just one single gate, i.e. one entry or inlet into the mould cavity. In this case, a more complicated distribution system may be required comprising a hotrunner (a distributor) and several nozzles and gates. By means of the distribution system the hot melt, i.e. the liquid plastic material, coming from the supply system, for example a barrel of a injection moulding system, is distributed to the different gates of the tool. A heating system may control the temperature of the liquid plastic material in (at least parts of) the distribution system and the nozzles.

Depending on the injection technology applied, the different nozzles of the distribution system may be either opened during the whole injection moulding process (open nozzles) or the nozzles (shutoff nozzle) may be individually opened and closed at specific times of the injection moulding process. A sequential injection moulding process with shutoff nozzles may have the advantage that the formed part is filled sequentially by the controlled opening and closing of the individual nozzles.

When parts with complicates design are formed by injection moulding it may be important that liquid plastic material is injected slowly into the (maybe complicated formed) mould cavity, because otherwise so called tiger stripes may occur. If the liquid plastic material is injected too fast, it may not cool down homogenously, but already cured plastic material may be again liquefied by hot liquid plastic material. This may result in an inhomogeneous appearance of the moulded part with stripes, which are called tiger stripes.

To circumvent this problem, in particular in sequential filling, nozzles may be used that are adapted for regulating the pressure of the liquid plastic material during the injection into the mould cavity.

### DESCRIPTION OF THE INVENTION

However, with such a design, the pressure of the liquid plastic material may be only regulated at the outlet of the nozzle or at least between the inlet and the outlet of the nozzle. Furthermore, such nozzles may have a complicated design, may be expensive and may be fault susceptible.

It may be an object of the invention to provide a simple system and a simple method for injection moulding parts without or with reduced tiger stripes.

It may be a further object of the invention to provide a system with which the mass flow of liquid plastic material is better controllable.

These objects are achieved by the subject-matter of the independent claims. Further exemplary embodiments are evident from the dependent claims and the following description.

An aspect of the invention relates to a distribution system of an injection moulding system.

According to an embodiment of the invention, the distribution system comprising an inlet for receiving pressurized liquid plastic material, at least a first nozzle and a second nozzle for injecting liquid plastic material into a mould cavity, and a distributor (for example a distributing line) for distributing the liquid plastic material from the inlet over (or through) a first flow path to the first nozzle and over (or through) a second flow path to the second nozzle. The distribution system is adapted for sequentially injecting liquid plastic material into the mould cavity via the first flow path and the second flow path.

In other words, the injection moulding system may be a sequential filling system that is adapted for sequentially injection liquid plastic material via different nozzle into a mould cavity.

According to an embodiment of the invention, the distribution system is adapted for reducing pressure energy of liquid plastic material in the distributor, when liquid plastic material is injected into the mould cavity via the first flow path. The pressure energy may be reduced in the distributor before the nozzles.

With such a distributor system, the temporarily stored pressure energy of liquid plastic material between the inlet (i.e. a supply system for generating liquid plastic material) and the outlet of a nozzle of the sequential injection moulding process (i.e. during the injection phase) may be minimized or at least reduced.

According to an embodiment of the invention, the distribution system comprises a distributor valve for closing at least a part of the second flow path before the second nozzle. The distribution valve may be any type of closing mechanism preventing liquid plastic material for entering a volume of the second flow path connected to the second nozzle. The temporarily stored pressure energy may be reduced by the valve by preventing liquid plastic material from entering at least a part of the second flow path, in particular the part that is not needed for distributing the liquid plastic material through the first flow path.

With such a distributor system, only melt volume, which needs to be pressurized for the required mass flow, may be pressurized. In other words, the volume of pressurized liquid plastic material in the distribution system may be reduced at a time, when liquid plastic material flows only through a part of the distribution system. Since the pressure energy of the liquid plastic material may be defined by pressure times volume, also the pressure energy is reduced. In particular, whenever a closing and/or opening function of a flow path is required, the second flow path (from the inlet connected to the supply system to the mould cavity) at the nearest possible position to the inlet may be closed. This may result in a minimal volume and therefore a minimal temporary storage of energy.

In such a way, the closing/and or opening function in a sequential filling process is not limited to the volume in between the nozzle inlet and the nozzle outlet.

According to an embodiment of the invention, the distributor valve (only) has a closed state and an opened state, for example the distributor valve may be a needle valve. The distributor valve may be designed very simple and thus may be very robust and cheap.

According to an embodiment of the invention, the distributor valve is a two-state valve, i.e. only may have an opened state and a closed state. When the valve is closed, the pressure resistance of the valve (between the inlet and the outlet of the valve) may be infinite. When the valve is opened, the pressure resistance may be minimized. The pressure resistance may be defined by the valve geometry (length, diameter, etc.), the material (viscosity) and the mass flow rate.

According to an embodiment of the invention, the distributor valve is adapted for reducing a pressure in liquid plastic material flowing through the valve. The distributor valve may be further adapted for reducing the pressure of the liquid plastic material before it enters the mould cavity. Additionally together with the other pressure reducing capabilities of the distribution system this may result in an even better controllability of the flow of the plastic material.

With such a distributor valve, the pressure resistance (from its inlet to its outlet may be regulated. The mass flow rate of liquid plastic material may be regulated within the valve geometry. In the case when the valve regulates the mass flow rate, the pressure resistance may be between the one of the closed state and the one of the opened position state.

According to an embodiment of the invention, the distributor comprises a first line connected to the inlet and the first nozzle and a second line connected to the first line and the second nozzle. The first flow path may comprise the first line and the first nozzle. The second flow path may comprise the first line, the second line and the second nozzle. In other words, the first and second flow paths may share common parts (i.e. the first line).

According to an embodiment of the invention, the distribution system comprises a (or the above mentioned) distributor valve for preventing liquid plastic material to flow though the second line. Due to this, (at least a part of) the volume of the second line after the distributor valve and the volume of the second nozzle may be separated from the first flow path.

It has to be understood that the terms “after” and “before” may refer to the positioning of the distributor valve with respect to the flow direction of the liquid plastic material, i.e. downstream and upstream, respectively.

According to an embodiment of the invention, the distributor comprises a branching point interconnecting the first line, the second line and the first nozzle. The distributor valve may be situated in the second line directly after the branching point. With such an arrangement, the volume of the second flow path that may be separated from the first flow path may be maximized.

According to an embodiment of the invention, the distributor comprises a third line connected to the second line and a third nozzle. The distribution system may comprise a second distributor valve for preventing liquid plastic material to flow through the third line.

According to an embodiment of the invention, a nozzle, for example the first and/or the second nozzle, comprises a nozzle valve for closing an outlet of the nozzle.

It may be possible that the distribution system only comprises valves in the distributor and not in the nozzles. However, for example for a further better controllability of the distribution system, conventional nozzles with needle valves may be used. At least one of the nozzles may be a shutoff nozzle that may comprise a shutoff needle for opening and/or closing the nozzle, so that a pressurized liquid plastic material cannot pass the nozzle outlet.

The nozzle valve may have the same functionality as the distributor valve, for example, it may also be adapted for regulating the mass flow rate of the liquid plastic material.

According to an embodiment of the invention, the distribution system further comprises a control unit for controlling the distributor valve(s) in the distributor and/or the needle valve(s) of the nozzles. In such a way, the controller may be adapted for controlling the mass flow of the plastic material in the distribution system very accurately. The control unit also may control the supply system.

A further aspect of the invention relates to an injection moulding system.

According to an embodiment of the invention, the injection moulding system comprises a supply system for generating liquid plastic material, a mould and a distribution system as described in the above and in the following for distributing the liquid plastic material from the supply system to the mould.

A further aspect of the invention relates to a method for injection moulding. The method may be performed with a distribution system as described in the above and in the following and may be automatically executed with a control unit as described in the above and in the following.

According to an embodiment of the invention, the method comprises the steps of: pressing liquid plastic material into a distribution system of an injection moulding system; injecting liquid plastic material over a first nozzle into a mould cavity, wherein the liquid plastic material is flowing over a first flow path to the first nozzle, while preventing liquid plastic material entering a second flow path to a second nozzle; opening a distributor valve such that liquid plastic material enters the second flow path; and injecting liquid plastic material over the second flow path into the mould cavity.

It has to be understood that features of the method as described in the above and in the following may be features of the system as described in the above and in the following.

These and other aspects of the invention will be apparent from and elucidated with reference to the embodiments described hereinafter.

### BRIEF DESCRIPTION OF THE DRAWINGS

The subject matter of the invention will be explained in more detail in the following text with reference to exemplary embodiments which are illustrated in the attached drawings.

FIG. 1 schematically shows an injection moulding system according to an embodiment of the invention.

FIG. 2 shows a three dimensional view of a distribution system according to an embodiment of the invention.

FIG. 3 shows a flow diagram for an injection moulding method according to an embodiment of the invention.

In principle, identical parts are provided with the same reference symbols in the figures.

### DETAILED DESCRIPTION OF EXEMPLARY EMBODIMENTS

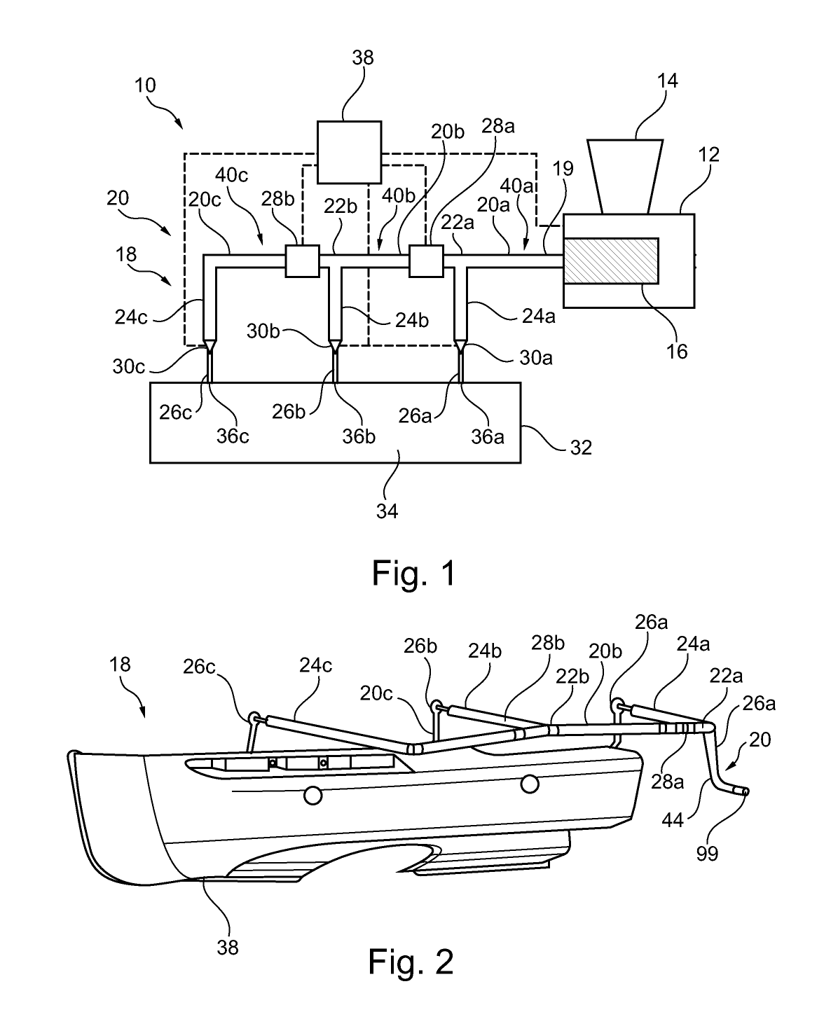

FIG. 1 shows an injection moulding system 10 with a supply system 12, a distribution system 18, a mould 32 and a control unit 38.

The supply system 12 for supplying the distribution system 18 with hot liquid plastic material (for example a polymer thermoplastic) comprises a hopper 14, which is adapted for providing granulate of the plastic material to a dosing system 16. The dosing system 16 may comprise a barrel for melting the plastic material and a (hydraulic, electrical) device which, by for example translational movement of the barrel, controls the mass flow rate of the liquid plastic material to the distribution system 18 (in a injection phase of the system 10) and/or the pressure level (in the packing phase of the system 10).

The supply system 12 comprises an outlet connected to an inlet 19 of the distribution system 18.

The distribution system 18 comprises a distributor (hotrunner) 20 for distributing the liquid plastic material from the supply system 12 to different gates 36a, 36b, 36c into the mould cavity 34. The distribution system 18 comprises nozzles 24a, 24b, 24c which are connected to the gates 36a, 36b, 36c and are adapted for injecting liquid plastic material into the mould cavity 34.

Outlets of the nozzles 24a, 24b, 24c are connected to the gates 36a, 36b, 36c.

The distributor 20 (which may be a distributor line 20) comprises hot channels or lines 20a, 20b, 20c interconnected via branching points 22a, 22b which distribute the liquid plastic material to the nozzles 24a, 24b, 24c. Outlets of the distributor 20 are connected to inlets of the nozzles 24a, 24b, 24c. The distributor 20 and the lines 20a, 20b, 20c may be heated.

The nozzles 24a, 24b, 24c may optionally comprise nozzle valves 30a, 30b, 30c for opening and closing the respective outlet of the nozzle 24a, 24b, 24c. The nozzle valves 30a, 30b, 30c may be needle valves and may be controlled by the control unit 38, which may also control the supply system 12.

The outlets of the nozzles 24a, 24b, 24c may be connected to inlets of optional cold channels 26a, 26b, 26c, which have outlets that provide the gates 30a, 36b, 30c to the mould cavity 34. The cold channels 26a, 26b, 26c may be seen as a coldrunner 26. The coldrunner 26 and the cold channels 26a, 26b, 26c are not heated and may be cooled.

The mould 32 comprises a mould cavity 34 and the gates 36a, 36b, 36c, which either connect the outlets of the nozzles 24a, 24b, 24c or the outlets of the coldrunner 26 with the inlets of the mould cavity 34. The mould cavity 34 is the cavity of the system 10 forming the volume of the part to be moulded.

The distribution system 18 further comprises distributor valves 28a, 28b that may be needle valves and that may only be adapted to close and open completely. The distributor valves 28a, 28b may be controlled by the control unit 38.

With the distribution system 18, several flow paths 40a, 40b, 40c for liquid plastic material are defined between the inlet 19 and the gates 30a, 36b, 30c of the mould 32.

The first flow path 40a starts at the inlet 19 and comprises the line 20a, the branching point 22a, the nozzle 24a and the cold channel 26a and ends at the gate 36a.

The second flow path 40b starts at the inlet 19 and comprises the line 20a, the branching points 22a, the line 20b, the branching point 22b, the nozzle 24b and the cold channel 26b and ends at the gate 36b. The second flow path 40b may be interrupted with the distributor valve 28a (directly) after the branching point 22a.

The third flow path 40c starts at the inlet 19 and comprises the lines 20a, 20b, 20c, the branching points 22a, 22b, the nozzle 24c and the cold channel 26C and ends at the gate 36C. The third flow path 40c may be interrupted with the distributor valve 28b (directly) after the branching point 22b or with the distributor valve 28a (directly) after the branching point 22a.

With the distributor valves 28a, 28b, the flow paths 40b, 40c may be interrupted or closed in such a way that only liquid plastic material may enter the parts of the distribution system 18 that are needed for a mass flow to one of the gates 36a, 36b, 36c. The parts of the distribution system 18 that would be subjected for being filled with plastic material under pressure without mass flow are disconnected from the rest of the distribution system 18.

FIG. 2 shows a three dimensional view of a distribution system 18 that may be used for moulding a bumper 42. The distribution system 18 may comprise a supply line 44 for supplying liquid plastic material from the inlet 19 to the distributor 20.

The translational movement of the barrel of the dosing system 16 may be the only energy source for filling the mould cavity 34 in the injection phase and to pressurize the liquid plastic material injected in the packing phase until it cools down and solidifies. Only with the translational movement of the barrel, the mass flow rates and the pressure of the liquid plastic material filling the mould cavity 34 may be controlled.

In the distribution system 18 with more than one gate 36a, 36b, 36c, the individual mass flow rates through the distributor 20 and the nozzles 24a, 24b, 24c becomes more complex. In this case, the individual mass flow rate of any flow path 40a, 40b, 40c directly depends on the pressure resistance at a specific time. Generally spoken, flow paths with high pressure resistance will have a reduced mass flow at a specific time and vice versa. The total mass flow through the distribution system 18 is determined with the translational movement of the barrel and correspond with the mass flow rate at the entrance of the distribution system 18.

Consequently, flow paths 40a, 40b, 40c of a distribution system 18 defined by infinite flow resistance will have a mass flow rate of zero. This, for instance, is the case, if a certain shutoff nozzle 24a, 24b, 24c or distribution valve 28a, 28b of the distribution system 18 is closed at a specific time of the injection phase.

Due to a infinite flow resistance of a flow path 40a, 40b, 40c, the volume of the liquid plastic material becomes pressurized instead in the respective flow path 40a, 40b, 40c. The pressure level of the liquid plastic material within the flow path 40a, 40b, 40c will thereby correspond with the pressure level of the liquid plastic material at a position, where the mass flow rate at the same time is not zero, i.e. the branching points 22a, 22b.

Due to the pressure of liquid plastic material without any mass flow rate the liquid plastic material is compressed and energized. The energy is temporarily stored in the liquid plastic material. Therefore, the temporarily energized volume of the liquid plastic material (between the branching point 22a, 22b and the outlet of the nozzle 24a, 24b, 24c) influences the controllability of the mass flow rate of injection moulding process. With the distribution valves 28a, 28b, the amount of liquid plastic material without mass flow may be minimized and the controllability of the system 10 may be enhanced.

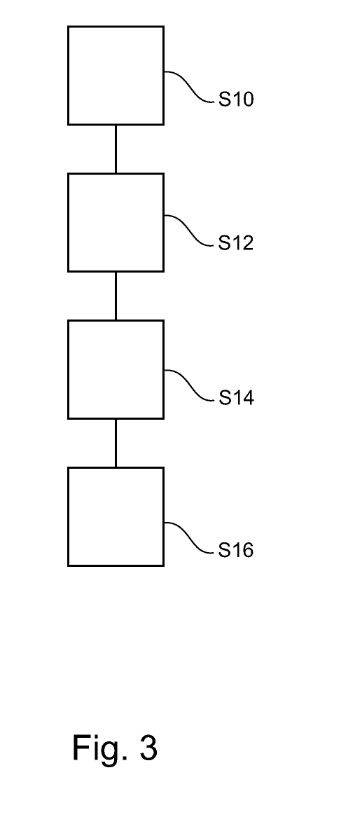

FIG. 3 shows a flow diagram for a injection moulding method that may be automatically performed with the moulding system 10 under the control of the control unit 38.

In step S10 liquid plastic material is molten in the supply system 12 and pressed into the distribution system 18 by the dosing system 16.

In step S12, the liquid plastic material is injected into the mould cavity 34 over the nozzle 24a. The liquid plastic material flows over the first flow path 40a to the first nozzle 24a. Due to the closed distributor valve 28a, liquid plastic material is prevented from entering the second flow 40b path to a second nozzle 24b.

In step S14, the control unit 38 opens the distributor valve 28a such that liquid plastic material enters the second flow path 40b and in particular the hot channel line 30b. When the nozzle 24a is a shutoff nozzle, the nozzle 24a may be closed after the opening of the distribution valve 28a. However, the mass flow of liquid plastic material through the nozzle 24a may be stopped when the mould cavity 34 is completely filled in the area of the nozzle 24a.

In step S16, liquid plastic material is injected over the second flow path 40b and via the nozzle 24b into the mould cavity.

The steps S14 and S16 may be repeated in a similar fashion for the third flow path 40c and the second distributor valve 28.

With the system 10, an sequential injection moulding processes may be performed with opening/closing sequences of the distribution valves 28a, 28b and optionally of the individual shutoff nozzles 24a, 24b, 24c.

The flow rate of the liquid plastic material through the individual gates 36a, 36b, 36c during the injection phase is of high importance as it directly determines the flow front speed of the liquid plastic material filling the mould cavity 34. High quality processes target constant flow front speeds of the melt filling the part cavity.

With the system 10, at any time of the process an exact controllability of the mass flow rate and flow front speeds (gating location) in the mould cavity 34 is possible.

With the system 10, the throughput through the gates ,may be controlled via the supply system 12 so, that the flow front speed within the mould cavity 34 over the injection moulding phase is constant all the time. Otherwise, surface defects, shear heating, shear layered structure, tiger stripes, extensive melt temperature would occur.

With the system 10, volumes without mass flow may be avoided, which store energy and which may hinder a direct control (energy communication) from the energy source (controlled movement of the barrel) to the gating location 36a, 36b, 36c of the mould cavity 34.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practising the claimed invention, from a study of the drawings, the disclosure, and the appended claims. In the claims, the word “comprising” does not exclude other elements or steps, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

1. A distribution system of an injection moulding system, the distribution system comprising:
an inlet for receiving pressurized liquid plastic material;
at least a first nozzle and a second nozzle for injecting liquid plastic material into a mould cavity;
a hotrunner distributor for distributing the liquid plastic material from the inlet over a first flow path to the first nozzle and over a second flow path to the second nozzle, said nozzle comprising a nozzle valve for closing an outlet of the nozzle;
a distributor valve for closing the second flow path before the second nozzle;
wherein the distribution system is adapted for sequentially injecting liquid plastic material into the mould cavity via the first flow path and the second flow path;
wherein the distribution system is adapted for reducing pressure energy of liquid plastic material in the distributor, when liquid plastic material is injected into the mould cavity via the first flow path.

2. The distribution system of claim 1,
wherein the distributor valve has a closed state and an opened state.

3. The distribution system of claim 1,
wherein the distributor valve is a two-state valve.

4. The distribution system of claim 1,
wherein the distributor valve is adapted for reducing a pressure in liquid plastic material flowing through the distributor valve.

5. The distribution system of claim 1,
wherein the distributor comprise a first line connected to the inlet and the first nozzle and a second line connected to the first line and the second nozzle,
wherein the distribution system comprises a distributor valve for preventing liquid plastic material to flow through the second line.

6. The distribution system of claim 5,
wherein the distributor comprises a branching point interconnecting the first line, the second line and the first nozzle,
wherein the distributor valve is situated in the second line directly after the branching point.

7. The distribution system of claim 5,
wherein the distributor comprises a third line connected to the second line and a third nozzle,
wherein the distribution system comprises a second distributor valve for preventing liquid plastic material to flow through the third line.

8. The distribution system of claim 1,
wherein the nozzle valve is a needle valve.

9. The distribution system of claim 1, further comprising:
a control unit (38) for controlling the distributor valve.

10. An injection moulding system, comprising:
a supply system for generating liquid plastic material;
a mould;
a distribution system for distributing the liquid plastic material from the supply system to the mould;
wherein the distribution system comprises:
an inlet for receiving pressurized liquid plastic material;
at least a first nozzle and a second nozzle for injecting liquid plastic material into a mould cavity;
a hotrunner distributor for distributing the liquid plastic material from the inlet over a first flow path to the first nozzle and over a second flow path to the second nozzle, said nozzle comprising a nozzle valve for closing an outlet of the nozzle;
a distributor valve for closing the second flow path before the second nozzle;
wherein the distribution system is adapted for sequentially injecting liquid plastic material into the mould cavity via the first flow path and the second flow path;
wherein the distribution system is adapted for reducing pressure energy of liquid plastic material in the distributor, when liquid plastic material is injected into the mould cavity via the first flow path.

11. A method for injection moulding, comprising the steps of:
pressing liquid plastic material into a distribution system of an injection moulding system;
injecting liquid plastic material over a first nozzle into a mould cavity, wherein the liquid plastic material is flowing over a first flow path to the first nozzle, while preventing liquid plastic material to enter a second flow path to a second nozzle;
opening a distributor valve such that liquid plastic material enters the second flow path;
closing the nozzle after the opening of the distributor valve;
injecting liquid plastic material over the second flow path into the mould cavity.
